(19) United States
(12) Patent Application Publication
(10) Pub. No.: US 2025/0060243 A1
(43) Pub. Date: Feb. 20, 2025

(54) Scale Caddy Device

(71) Applicant: Brad Senatore, Key Biscayne, FL (US)

(72) Inventor: Brad Senatore, Key Biscayne, FL (US)

(21) Appl. No.: 18/800,270

(22) Filed: Aug. 12, 2024

Related U.S. Application Data
(60) Provisional application No. 63/520,123, filed on Aug. 17, 2023.

(51) Int. Cl. G01G 23/00; G01G 19/44

(52) U.S. Cl. CPC G01G 23/00; G01G 19/44

(57) ABSTRACT

A scale caddy device is provided comprised of a wall-mounted base and a hinged scale holder attached to the base. During use, the base attaches to a wall surface. The scale holder, which can rotate downwards for use, secures a scale within the scale holder using sliding rods and repositionable supports. When not in use, the holder can be locked to the base in an upright position parallel to the wall and to a vertical axis of the base, thereby not obstructing the floor of a bathroom. When in use, the scale holder can be rotated downwards such that it becomes generally perpendicular to the vertical axis of the base and such that the scale can be slid outwards from the scale holder along the sliding rod to allow a user to step on the scale as the rod rests on the floor surface.

### CROSS-REFERENCE TO RELATED APPLICATION

The present application claims priority to, and the benefit of, U.S. Provisional Application No. 63/520,123, which was filed on Aug. 17, 2023, and is incorporated herein by reference in its entirety.

### FIELD OF THE INVENTION

The present invention relates generally to the field of weighing scales. More specifically, the present invention relates to a scale caddy device that allows a weighing scale to be stored within a bathroom (or other area) in a manner that does not create an obstruction or tripping hazard when the scale is not in use. Accordingly, the present disclosure makes specific reference thereto. Nonetheless, it is to be appreciated that aspects of the present invention are also equally applicable to other like applications, devices, and methods of manufacture.

### BACKGROUND

Bathrooms are often designed to be quite compact, leaving very limited space for any additional items such as a scale. Unfortunately, due to a constrained layout, finding a suitable spot to place a scale becomes a significant challenge. Placing it in a way that doesn't obstruct the door's path or pose a tripping hazard is particularly problematic. Moreover, the lack of available space means that one would need to awkwardly bend down, retrieve the scale, use it, and then carefully maneuver it back into place after each use. This not only makes the process of using the scale cumbersome but also raises safety concerns given the potential for accidents or inconvenience caused by the scale's placement.

The compact nature of bathrooms can also lead to other issues. For instance, the presence of moisture and humidity in such a confined space can affect the functionality and durability of the scale. Additionally, the lack of adequate storage options can make it difficult to keep the bathroom organized and free from clutter. Items like scales often end up being placed in less-than-ideal locations, such as under the sink or behind the toilet, which can make accessing them even more cumbersome.

In many cases, individuals may resort to creative solutions to overcome these spatial challenges such as placing the scale in a nearby hallway or bedroom. However, these solutions are not always practical or convenient. This is especially true for those who prefer to use the scale immediately after showering or getting ready in the bathroom.

Therefore, there exists a long-felt need in the art for an improved storage solution for a scale within a bathroom. There also exists a long-felt need in the art for a scale caddy device. Further, there exists a long-felt need in the art for a scale caddy device that can store a scale within a bathroom when the scale is not in use. More specifically, there exists a long-felt need in the art for a scale caddy device that can store a scale within a bathroom when the scale is not in use wherein the device allows the scale to be stored in an area that does not obstruct the use of the bathroom and does not create a tripping hazard.

The subject matter disclosed and claimed herein, in one embodiment thereof, comprises a scale caddy device. The device is comprised of a wall-mounted base and a hinged scale holder attached to the base. During use, the base attaches to a wall surface. The scale holder, which can rotate downwards for use, secures a weighing scale within the scale holder using sliding rods and repositionable supports to accommodate scales of different sizes. When not in use, the holder can be locked to the base in an upright position parallel to the wall and to a vertical axis of the base, thereby not obstructing the floor of a bathroom. When in use, the scale holder can be rotated downwards such that it becomes generally perpendicular to the vertical axis of the base and such that the scale can be slid outwards from the scale holder along the sliding rod to allow a user to step on the scale as the rod rests on the floor surface.

In this manner, the scale caddy device of the present invention accomplishes all the forgoing objectives and provides an improved storage solution for a scale within a bathroom. During use, the device allows a user to store a scale within a bathroom when the scale is not in use. More specifically, the device allows a user to store a scale within a bathroom when the scale is not in use, wherein the device allows the scale to be stored in an area that does not obstruct the use of the bathroom and does not create a tripping hazard.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a scale caddy device. The device is comprised of a wall-mounted base and a scale holder that attaches to the base and receives a weighing scale when the scale is not in use. The base is comprised of at least one opening that allows at least one fastener (such as but not limited to a screw or a nail) to be driven through the base in order to secure the base to a wall surface (or other surface).

At least one scale holder attaches to the base via at least one hinge. The hinge allows the scale holder to rotate downwards 90 degrees (relative to a vertical axis of the base) when deployed. When the device is undeployed, the base is secured vertically on a wall surface and the scale holder is stored generally parallel to a vertical axis of the base and of the wall surface. When stored in the upright, undeployed position, the scale holder can be further secured to the base via at least one locking mechanism.

More specifically, the scale holder may be comprised of a first wall, a second wall, and a third wall. The first wall attaches to the hinge, allowing the scale holder to attach to the base. The second wall connects the first wall to a third wall. The third wall secures and stores a scale within the scale holder. To do so, the top surface of the third wall is comprised of a plurality of scale-securing implements. This includes at least one sliding rod. The rod may be any structure that can slide outwards (i.e., away from the wall and the base) such that the scale attached to/resting on the rod can be pulled out from the holder, wherein the rod then rests on the ground surface in front of the holder to allow a user to step on the scale. When the scale is not in use, it can be secured within the holder via at least one, but preferably two, repositionable supports. The supports contact the left edge and right edge of the scale to prevent left/right movement of the scale within the scale holder while the device is being deployed and/or stored. The supports are preferably repositionable via a sliding, locking track that allows the distance between the supports to be increased or decreased as needed to accommodate scales of various widths.

The present invention is also comprised of a method of using the device. First, a device is provided comprised of a locking mechanism, a base, and a scale holder attached to the base via at least one hinge wherein the scale holder is comprised of at least one sliding rod and at least one sliding support that receives at least one scale. Then, the base can be secured to a wall surface, preferably within a bathroom, using a fastener. Next, a scale can be secured within the scale holder by adjusting the sliding supports such that the scale fits between and is secured within the supports. Once the scale is secured within the scale holder, the scale holder can be rotated towards the base about the hinge such that a third wall of the scale holder is parallel with a vertical axis of the base. The scale holder can then be locked into this position by engaging at least one locking mechanism of the device. To use the scale, the locking mechanism can be disengaged and the scale holder can be rotated downwards until it rests on a ground surface such that the third wall is preferably perpendicular to a vertical axis of the base and rests on the ground surface. Then, the scale can be slid outwards away from a second wall of the scale holder via the sliding rod, such that the rod fully or partially rests on the ground surface and a user can step on the scale to weigh themselves. When finished, a user can slide the scale back into the scale holder and rotate the holder back to a position wherein the third wall is parallel to the vertical axis of the base, wherein the scale holder can be locked in this undeployed position via once again engaging the locking mechanism.

Accordingly, the scale caddy device of the present invention is particularly advantageous as it provides an improved storage solution for a scale within a bathroom. During use, the device allows a user to store a scale within a bathroom when the scale is not in use. More specifically, the device allows a user to store a scale within a bathroom when the scale is not in use, wherein the device allows the scale to be stored in an area that does not obstruct the use of the bathroom and does not create a tripping hazard. In this manner, the scale caddy device overcomes the limitations of existing methods and devices used for storing bathroom scales known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a side view of one potential embodiment of a scale caddy device of the present invention while in the stored/undeployed position and attached to a wall surface in accordance with the disclosed architecture;

FIG. 2 illustrates a perspective view of one potential embodiment of a scale caddy device of the present invention while in the deployed position with a scale attached to the scale holder in accordance with the disclosed architecture;

FIG. 3 illustrates a perspective view of one potential embodiment of a scale caddy device of the present invention while in the deployed position in accordance with the disclosed architecture; and

FIG. 4 illustrates a flowchart of a method of using one potential embodiment of a scale caddy device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved storage solution for a scale within a bathroom. There also exists a long-felt need in the art for a scale caddy device. Further, there exists a long-felt need in the art for a scale caddy device that can store a scale within a bathroom when the scale is not in use. More specifically, there exists a long-felt need in the art for a scale caddy device that can store a scale within a bathroom when the scale is not in use wherein the device allows the scale to be stored in an area that does not obstruct the use of the bathroom and does not create a tripping hazard.

The present invention, in one exemplary embodiment, is comprised of a scale caddy device comprised of a wall-mounted base and a scale holder that attaches to the base that receives a weighing scale when the scale is not in use. The base is comprised of at least one opening that allows at least one fastener (such as but not limited to a screw or a nail) to be driven through the base in order to secure the base to a wall surface (or other surface).

At least one scale holder attaches to the base via at least one hinge that allows the scale holder to rotate downwards 90 degrees (relative to a vertical axis of the base) when deployed. When the device is undeployed, the base is secured vertically on a wall surface and the scale holder is stored generally parallel to a vertical axis of the base and of the wall surface. When stored in the upright, undeployed position, the scale holder can be further secured to the base via at least one locking mechanism.

More specifically, the scale holder may be comprised of a first wall, a second wall, and a third wall. The first wall attaches to the hinge, allowing the scale holder to attach to the base. The second wall connects the first wall to a third wall. The third wall secures and stores a scale within the scale holder. To do so, the top surface of the third wall is comprised of a plurality of scale-securing implements that includes at least one sliding rod. The rod may be any structure that can slide outwards (i.e., away from the wall and the base) such that the scale attached to/resting on the rod can be pulled out from the holder, wherein the rod then rests on the ground surface in front of the holder to allow a user to step on the scale. When the scale is not in use, it can be secured within the holder via at least one, but preferably two, repositionable supports. The supports contact the left edge and right edge of the scale to prevent left/right movement of the scale within the scale holder while the device is being deployed and/or stored. The supports are preferably repositionable via a sliding, locking track that allows the distance between the supports to be increased or decreased as needed to accommodate scales of various widths.

The present invention is also comprised of a method of using the device. First, a device is provided comprised of a locking mechanism, a base, and a scale holder attached to the base via at least one hinge wherein the scale holder is comprised of at least one sliding rod and at least one sliding support that receives at least one scale. Then, the base can be secured to a wall surface, preferably within a bathroom, using a fastener. Next, a scale can be secured within the scale holder by adjusting the sliding supports such that the scale fits between and is secured within the supports. Once the scale is secured within the scale holder, the scale holder can be rotated towards the base about the hinge such that a third wall of the scale holder is parallel with a vertical axis of the base. The scale holder can then be locked into this position by engaging at least one locking mechanism of the device. To use the scale, the locking mechanism can be disengaged and the scale holder can be rotated downwards until it rests on a ground surface such that the third wall is preferably perpendicular to a vertical axis of the base and rests on the ground surface. Then, the scale can be slid outwards away from a second wall of the scale holder via the sliding rod, such that the rod fully or partially rests on the ground surface and a user can step on the scale to weigh themselves. When finished, a user can slide the scale back into the scale holder and rotate the holder back to a position wherein the third wall is parallel to the vertical axis of the base, wherein the scale holder can be locked in this undeployed position via once again engaging the locking mechanism.

Accordingly, the scale caddy device of the present invention is particularly advantageous as it provides an improved storage solution for a scale within a bathroom. During use, the device allows a user to store a scale within a bathroom when the scale is not in use. More specifically, the device allows a user to store a scale within a bathroom when the scale is not in use, wherein the device allows the scale to be stored in an area that does not obstruct the use of the bathroom and does not create a tripping hazard. In this manner, the scale caddy device overcomes the limitations of existing methods and devices used for storing bathroom scales known in the art.

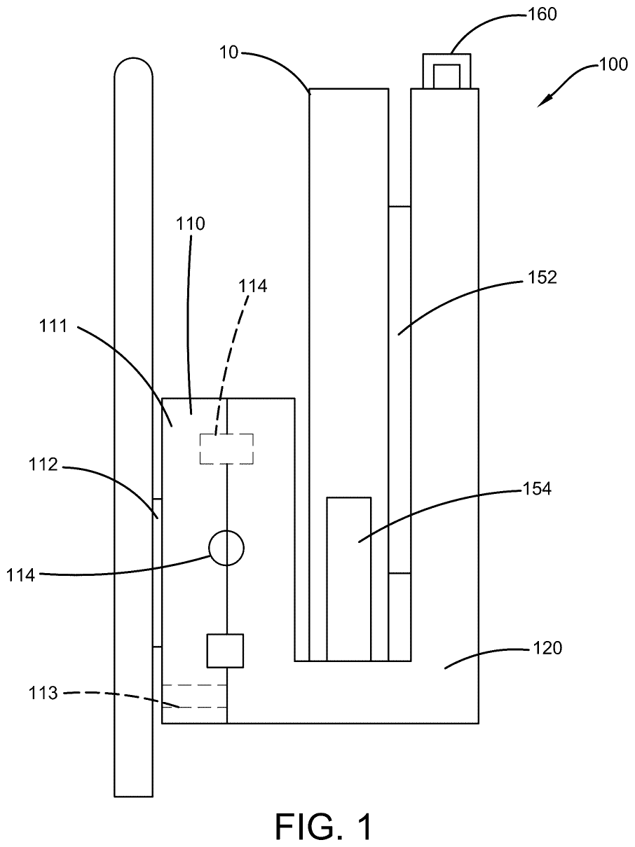

Referring initially to the drawings, FIG. 1 illustrates a side view of one potential embodiment of a scale caddy device 100 of the present invention while in the stored/undeployed position in accordance with the disclosed architecture. The device 100 is comprised of a wall-mounted base 110 and a scale holder 120 that attaches to the base 110 and receives a weighing scale 10 when the scale 10 is not in use. The base 110 and scale holder 120 may be made from any material and have any fit/finish in different embodiments. However, the base 110 and holder 120 are preferably made from a mold and mildew-resistant material that is preferably waterproof (suitable for humid bathroom use).

The base 110 may be any shape in different embodiments. In one embodiment, the base 110 attaches to a wall surface (or other surface) via at least one fastener 112 that is positioned on the base 110 (preferably on a rear surface 111 of the base 110), such as but not limited to a suction cup fastener, an adhesive fastener, a magnetic fastener, etc. In a different embodiment, the base 110 is comprised of at least one opening 113 that allows at least one fastener (such as but not limited to a screw or a nail) to be driven through the base 110 in order to secure the base 110 to a wall surface (or other surface). The base 110 is preferably secured to the wall surface only slightly above a ground surface/floor to allow the scale holder 120 to articulate in a manner that will be described more fully below.

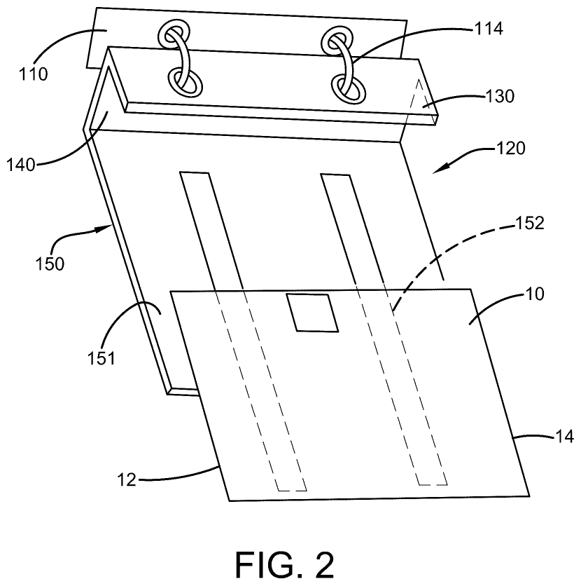

At least one scale holder 120 attaches to the base 110 via at least one hinge 114. The hinge 114 may be any hinge type but is preferably an assisted hinge to allow the scale holder 120 to rotate downwards 90 degrees (relative to a vertical axis of the base) when deployed, as seen in FIG. 2. When the device 100 is undeployed, the base 110 is secured vertically on a wall surface and the scale holder 120 is stored generally parallel to a vertical axis of the base 110 and of the wall surface, as seen in FIG. 1. When stored in the upright, undeployed position, the scale holder 120 can be further secured to the base 110 via at least one locking mechanism 114, as seen in FIG. 1. The locking mechanism 114 may be any type known in the art such as but not limited to a push-button locking mechanism, a latch, a foot-pedal-activated locking mechanism, a magnetic locking mechanism, etc. Deploying the scale holder 120 may be assisted by at least one handle 160 of any type located on the scale holder 120.

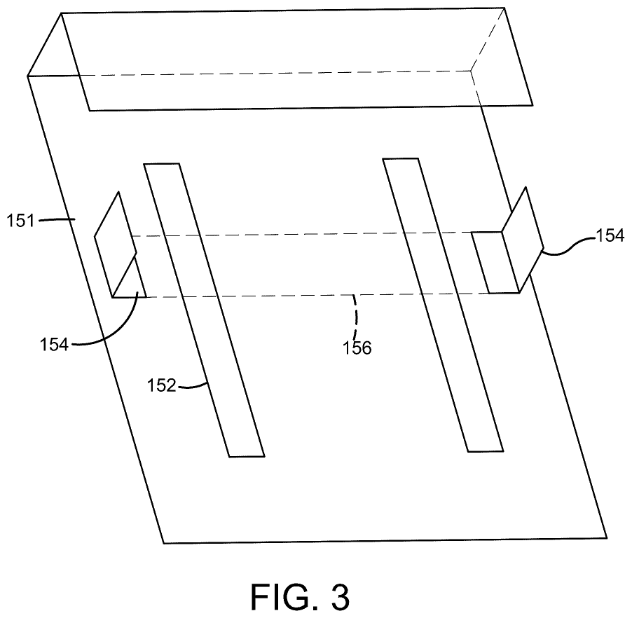

More specifically, the scale holder 120 may be comprised of a first wall 130, a second wall 140, and a third wall 150. The first wall 130 attaches to the hinge 114, allowing the scale holder 120 to attach to the base 110. The second wall 140 connects the first wall 130 to a third wall 150. The third wall 150 secures and stores a scale 10 within the scale holder 120. To do so, the top surface 151 of the third wall 150 is comprised of a plurality of scale-securing implements. This includes at least one sliding rod 152. The rod 152 may be any structure that can slide outwards (i.e., away from the wall and the base 110) such that the scale 10 attached to/resting on the rod 152 can be pulled out from the holder 120, wherein the rod 152 then rests on the ground surface in front of the holder 120 to allow a user to step on the scale 10, as seen in FIG. 2. When the scale 10 is not in use, it can be secured within the holder 120 via at least one, but preferably two, repositionable supports 154. The supports 154 contact the left edge 12 and right edge 14 of the scale 10. The supports 154 are preferably L-shaped (i.e., form a 90-degree angle), but may be any shape that can prevent left/right movement of the scale 10 within the scale holder 120 while the device 100 is being deployed and/or stored. The supports 154 are preferably repositionable via a sliding, locking track 156 that allows the distance between the supports 154 to be increased or decreased as needed to accommodate scales of various widths, as seen in FIG. 3. In one embodiment, the supports 154 are integrally attached to (and move with) the sliding rod 152 to ensure the scale 10 is continuously secure during all phases of use.

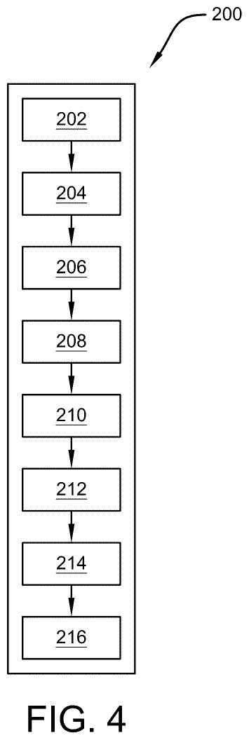

The present invention is also comprised of a method of using 200 the device 100, as seen in FIG. 4. First, a device 100 is provided comprised of a locking mechanism 114, a base 110, and a scale holder 120 attached to the base 110 via at least one hinge 114 wherein the scale holder 120 is comprised of at least one sliding rod 152 and at least one sliding support 154 that receive at least one scale 10 [Step 202]. Then, the base 110 can be secured to a wall surface, preferably within a bathroom, using a fastener 112 (or other fastener such as but not limited to a screw or a nail) [Step 204]. Next, a scale 10 can be secured within the scale holder 120 by adjusting the sliding supports 154 such that the scale 10 fits between and is secured within the supports 154 [Step 206]. Once the scale 10 is secured within the scale holder 120, the scale holder 120 can be rotated towards the base 110 about the hinge 114 such that a third wall 150 of the scale holder 120 is parallel with a vertical axis of the base 110 [Step 208]. The scale holder 120 can then be locked into this position via engaging at least one locking mechanism 114 of the device 100 [Step 210]. To use the scale 10, the locking mechanism 114 can be disengaged and the scale holder 120 can be rotated downwards until it rests on a ground surface such that the third wall 150 is preferably perpendicular to a vertical axis of the base 110 and rests on the ground surface [Step 212]. Then, the scale 10 can be slid outwards away from a second wall 140 of the scale holder 120 via the sliding rod 152, such that the rod 152 fully or partially rests on the ground surface and a user can step on the scale 10 to weigh themselves [Step 214]. When finished, a user can slide the scale 10 back into the scale holder 120 and rotate the holder 120 back to a position wherein the third wall 150 is parallel to the vertical axis of the base 110, wherein the scale holder 120 can be locked in this undeployed position via once again engaging the locking mechanism 114 [Step 216].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “scale caddy device” and “device” are interchangeable and refer to the scale caddy device 100 of the present invention.

Notwithstanding the forgoing, the scale caddy device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the scale caddy device 100 as shown in the FIGS. are for illustrative purposes only, and that many other sizes and shapes of the scale caddy device 100 are well within the scope of the present disclosure. Although the dimensions of the scale caddy device 100 are important design parameters for user convenience, the scale caddy device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A scale caddy device comprising:
a base;
a scale holder comprised of:
a sliding rod;
a sliding support;
a locking mechanism; and
a hinge attached to the base and the scale holder.

2. The scale caddy device of claim 1, wherein the hinge is comprised of an assisted hinge.

3. The scale caddy device of claim 1, wherein the locking mechanism secures the scale holder to the base.

4. The scale caddy device of claim 1, wherein the locking mechanism is comprised of a push-button locking mechanism, a latch, a foot-pedal-activated locking mechanism, or a magnetic locking mechanism.

5. The scale caddy device of claim 1, wherein the base and the scale molder are comprised of a mold-resistant material.

6. The scale caddy device of claim 1, wherein the base and the scale molder are comprised of a mildew-resistant material.

7. The scale caddy device of claim 1, wherein the base is comprised of an opening.

8. A scale caddy device comprising:
a base;
a scale holder comprised of:
a sliding rod;
a first sliding support and a second sliding support;
a locking mechanism; and
a hinge attached to the base and the scale holder.

9. The scale caddy device of claim 8, wherein the base is comprised of a fastener.

10. The scale caddy device of claim 8, wherein the first sliding support is connected to the second sliding support by a sliding track.

11. The scale caddy device of claim 8, wherein the first sliding support and the second sliding support are repositionable.

12. The scale caddy device of claim 8, wherein the first sliding support and the second sliding support are attached to the sliding rod.

13. The scale caddy device of claim 8, wherein the sliding rod is repositionable.

14. The scale caddy device of claim 8, wherein the sliding rod slides outwards from the scale holder, away from a second wall of the scale holder.

15. The scale caddy device of claim 8, wherein the first sliding support forms a 90-degree angle.

16. The scale caddy device of claim 8, wherein the second sliding support forms a 90-degree angle.

17. The scale caddy device of claim 8, wherein the scale holder is comprised of a handle.

18. A method of using a scale caddy device, the method comprising the following steps:
providing a scale caddy device comprised of a locking mechanism, a base, and a scale holder attached to the base via a hinge wherein the scale holder is comprised of a sliding rod and a sliding support that receive a scale;
attaching the base to a wall surface;
securing a scale within the scale holder via the sliding support;
rotating the scale holder towards the base such that a third wall of the scale holder is parallel with a vertical axis of the base, and locking the scale holder to the base in this position via the locking mechanism;
disengaging the locking mechanism and rotating the scale holder downwards towards a ground surface until the third wall is perpendicular to the vertical axis of the base;
sliding the scale outwards away from a second wall of the scale holder via the sliding rod such that the scale fully or partially rests on the ground surface;
stepping on the scale; and
sliding the scale back into the scale holder and rotating the scale holder back into a position wherein the third wall of the scale holder is parallel with the vertical axis of the base, and locking the scale holder to the base in this position via the locking mechanism.

19. The method of using a scale caddy device of claim 18, wherein the hinge is comprised of an assisted hinge.

20. The method of using a scale caddy device of claim 18, wherein the sliding support is attached to the sliding rod.
